(19) United States
(12) Patent Application Publication
(10) Pub. No.: US 2021/0167371 A1
(43) Pub. Date: Jun. 3, 2021

(54) METHOD FOR PREPARING A LITHIUM SECONDARY BATTERY AND A LITHIUM SECONDARY BATTERY PREPARED THEREBY

(71) Applicants: HYUNDAI MOTOR COMPANY, Seoul (KR); KIA MOTORS CORPORATION, Seoul (KR)

(72) Inventors: Yoon Ji Lee, Bucheon-si (KR); Dong Hui Kim, Suwon-si (KR); Jin Hee Lee, Changwon-si (KR); Sang Mok Park, Gwangju-si (KR); Young Woo Lee, Suwon-si (KR); Seung Ho Ahn, Hanam-si (KR)

(73) Assignees: HYUNDAI MOTOR COMPANY, Seoul (KR); KIA MOTORS CORPORATION, Seoul (KR)

(21) Appl. No.: 16/849,486

(22) Filed: Apr. 15, 2020

(30) Foreign Application Priority Data
Nov. 28, 2019 (KR) 10-2019-0155951

(51) Int. Cl. H01M 4/38; H01M 4/134; H01M 4/62; H01M 4/04; H01M 2/26; H01M 2/16; H01M 10/0525

(52) U.S. Cl. CPC H01M 4/386; H01M 4/134; H01M 4/621; H01M 2004/021; H01M 2/266; H01M 2/1673; H01M 10/0525; H01M 4/0435

(57) ABSTRACT

A method for preparing a lithium secondary battery that includes Si in an anode includes: an electrode plate process step of preparing a cathode plate using a cathode active material, a conductive material and a binder, and of preparing an anode plate using an anode active material including Si, a conductive material, and a binder; an assembly process step of assembling the cathode plate and the anode plate in a state in which a separator is interposed between the cathode plate and the anode plate, and of injecting an electrolyte into the resultant assembly, thereby preparing a cell; and an activation process step of aging and degassing the prepared cell, and of performing a formation process for the cell in a pressurized environment, thereby suppressing volume swelling of the cell.

### CROSS-REFERENCE TO RELATED APPLICATION

This application claims priority to Korean Patent Application No. 10-2019-0155951, filed on Nov. 28, 2019, in the Korean Intellectual Property Office, the disclosure of which is incorporated herein by reference.

### BACKGROUND

### 1. Field of the Disclosure

The present disclosure relates to a method for preparing a lithium secondary battery and a lithium secondary battery prepared thereby. More particularly, the present disclosure relates to a lithium secondary battery preparation method in which silicon (Si) is included in an anode. An activation process is provided to perform a formation process in a pressurized environment in order to solve a volume swelling problem, for preparation of a lithium secondary battery with a high capacity, and a lithium secondary battery prepared by the lithium secondary battery preparation method.

### 2. Description of the Related Art

To cope with the growth of information technology (IT) and vehicle battery markets, technical research is being continuously conducted into the industry of lithium secondary batteries which are core elements of energy storage. Lithium secondary batteries have several advantages such as high energy density, superior lifespan characteristics and low self-discharge energy storage. By virtue of such advantages, lithium secondary batteries are applied to various application fields associated with notebook computers, portable phones, electric vehicles, and the like. In particular, the importance of lithium secondary batteries as energy storage has increased.

Since commercial availability of lithium secondary batteries began in the early 1990's, a graphite-based material has been used as an anode material of lithium secondary batteries. However, the graphite-based anode material currently exhibits a capacity limitation in that the capacity thereof approximates to a theoretical capacity. The graphite-based anode material also has a limitation in realizing a high-capacity battery needed in recently developed electronic appliances. Furthermore, high-capacity anode materials are needed in markets of electric vehicles and medium/large batteries for energy storage systems (ESSs). In connection with this, Si and tin (Sn) anode materials are being highlighted, in place of existing graphite-based materials. Research thereinto is being continuously conducted.

Si, which exhibits the highest theoretical capacity (4,200 mAh/g) among anode materials of lithium secondary batteries, has advantages in that Si exhibits a low potential difference from lithium and is eco-friendly, and Si reserves are rich. However, Si has a drawback in that the volume of Si may be abruptly swelled during intercalation and deintercalation of lithium ions in a lithium secondary battery. Therefore, Si particles may be disintegrated, thereby resulting in loss of lithium ion storage spaces causing an abrupt capacity reduction. Although Si exhibits a theoretical capacity corresponding to 10 times or more the theoretical capacity of graphite, Si exhibits a volume variation corresponding to 20 times or more the theoretical volume variation of graphite.

Currently, active research is being conducted in order to overcome the drawback of the above-mentioned Si-based anode. However, conventional technologies have concentrated on research into binders for improvement of Si materials such as surface modification or suppression of volume swelling of Si materials or research into electrode structures in order to achieve stabilization of an Si-based anode. Even in such conventional technologies, complicated processes may be required, and there is a difficulty in practical use. Furthermore, such conventional technologies have a limitation in solving fundamental problems associated with anode materials.

Therefore, development of a method for preparing a lithium secondary battery, which can solve a volume swelling problem while including Si in an anode, is currently required.

The above matters disclosed in this section are merely for enhancement of understanding of the general background of the disclosure and should not be taken as an acknowledgement or any form of suggestion that the matters form the related art already known to a person of ordinary skill in the art.

### SUMMARY

Therefore, the present disclosure has been made in view of the above problems. It is an object of the present disclosure to provide a method for preparing a lithium secondary battery with a high capacity, which is capable of solving a volume swelling problem while including Si in an anode by performing a formation process a plurality of times through the application of pressure in an activation process.

In accordance with an aspect of the present disclosure, the above and other objects can be accomplished by the provision of a method for preparing a lithium secondary battery including Si in an anode. The method includes: an electrode plate process step of preparing a cathode plate using a cathode active material, a conductive material and a binder, and of preparing an anode plate using an anode active material including Si, a conductive material, and a binder; an assembly process step of assembling the cathode plate and the anode plate in a state in which a separator is interposed between the cathode plate and the anode plate, and of injecting an electrolyte into the resultant assembly, thereby preparing a cell; and an activation process step of aging and degassing the prepared cell, and of performing a formation process for the cell in a pressurized environment, thereby suppressing volume swelling of the cell.

In the electrode plate process step, the anode active material may include 70-95% of graphite and 5-30% of Si based on weight ratio. Si may include at least one of a monolithic Si, an Si-carbon composite or an Si-metal composite.

The pressurized environment of the formation process in the activation process step may be an environment having a pressure of 2-6 kgf/cm².

The formation process in the activation process step may include execution of a formation cycle, in which charge and discharge of the cell are carried out a plurality of times, in a pressurized environment. The formation cycle may be executed 1-5 times.

Charge in the formation cycle may be carried out at 0.5C up to 4.2 V under a constant current-constant voltage (constant current/constant voltage) condition. Discharge in the formation cycle may be carried out at 0.5C up to 2.5 V under a constant current condition.

In the electrode plate process step, the cathode active material may be nickel-cobalt-manganese (NCM), the binder may be polyvinylidene fluoride (PVdF), and the conductive material may be graphite platelets.

The electrode plate process step may include preparing a slurry by dispersing the cathode active material, the binder and the conductive material in a ratio of 95%, 3% and 2% in N-methyl-2-pyrrolidone (NMP), coating the prepared slurry over an aluminum (Al) foil, and then subjecting the resultant structure to drying and roll pressing, thereby preparing a cathode plate.

The separator in the assembly process step may be a polyethylene (PE) separator coated with a ceramic having a thickness of 10 μm. The electrolyte in the assembly process step may be prepared by dissolving 1.0M lithium hexafluorophosphate (LiPF6) and lithium difluoro(oxalato)borate (LiDFOB) in a solvent of 20% of ethylene carbonate (EC), 50% of ethylmethyl carbonate (EMC) and 30% of diethyl carbonate (DEC) such that the weight ratio of 1.0M LiPF6 and LiDFOB to the electrolyte is 5%.

### BRIEF DESCRIPTION OF THE DRAWINGS

The above and other objects, features and other advantages of the present disclosure should be more clearly understood from the following detailed description taken in conjunction with the accompanying drawings, in which:

FIG. 1 is a flowchart illustrating a lithium secondary battery preparation method according to an embodiment of the present disclosure;

FIG. 2 is a graph depicting discharge capacity retention variation according to execution of a charge and discharge cycle in a lithium secondary battery of Example 4 and a lithium second battery of Comparative Example 1;

FIG. 3 is a graph depicting resistance increase variation according to execution of the charge and discharge cycle in the lithium secondary battery of Example 4 and the lithium second battery of Comparative Example 1;

FIG. 4 is a scanning electron microscope (SEM) photograph of an anode assembled in an assembly process step according to the illustrated embodiment of the present disclosure;

FIG. 5 is an SEM photograph of an anode in the lithium secondary battery of Example 4; and

FIG. 6 is an SEM photograph of an anode in the lithium secondary battery of Comparative Example 1.

### DETAILED DESCRIPTION OF THE EMBODIMENTS

Regarding the embodiments of the present disclosure disclosed herein, specific structural or functional descriptions are examples to merely describe the embodiments of the present disclosure. The embodiments of the present disclosure can be implemented in various forms and should not be interpreted as being limited to the embodiments described in the present specification.

It should be noted that the terms used herein are merely used to describe a specific embodiment, not to limit the present disclosure. Incidentally, unless clearly used otherwise, singular expressions include a plural meaning. In this application, the term “comprising,” “including,” or the like, is intended to express the existence of the characteristic, the numeral, the step, the operation, the element, the part, or the combination thereof, and does not exclude another characteristic, numeral, step, operation, element, part, or any combination thereof, or any addition thereto.

Unless defined otherwise, terms used herein including technological or scientific terms have the same meaning as generally understood by those of ordinary skill in the art to which the disclosure pertains. The terms used herein shall be interpreted not only based on the definition of any dictionary but also the meaning that is used in the field to which the disclosure pertains. In addition, unless clearly defined, the terms used herein shall not be interpreted too ideally or formally.

Further, when an element in the written description and claims is described as having a specific purpose or being “for” performing or carry out a stated function, process, step, set of instructions, or the like, the element may also be considered as being “configured to” do so.

Hereinafter, the present disclosure is described in detail below through description of various embodiments thereof with reference to the accompanying drawings.

The present disclosure relates to a method for preparing a lithium secondary battery, which is capable of solving a volume swelling problem of lithium in spite of preparation of a lithium secondary battery with a high capacity through inclusion of silicon (Si) in an anode.

When an anode plate is prepared under the condition in which Si is included in an anode active material, volume swelling caused by Si may continuously occur when charge and discharge are repeatedly carried out. Therefore, volume variation corresponding to 20 times or more volume variation of the case, in which a graphite-based anode active material is used, may occur. In this case, the anode active material may be deintercalated from a current collector. Therefore, there may be a problem in that the capacity and conductivity of the battery may be reduced. In addition, due to continuous volume swelling of Si, a solid electrolyte interface layer may be destabilized and, as such, may be easily degraded.

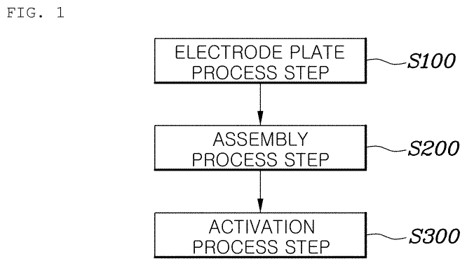

Referring to FIG. 1, a lithium secondary battery preparation method according to an embodiment of the present disclosure proposed to solve the above-described problems may include an electrode plate process step S100, an assembly process step S200, and an activation process step S300.

The electrode plate process step S100 is a process of preparing a cathode plate and an anode plate. In the electrode plate process step S100, each of the cathode plate and the anode plate is prepared by mixing an active material, i.e., a cathode active material or an anode active material, a conductive material, and a binder, and by performing coating, pressing, lamination, and slitting procedures for the resultant mixture. In the electrode plate process step S100, an anode active material including Si may be used. Therefore, Si may be included in a finally prepared anode plate.

The cathode active material may be nickel-cobalt-manganese (NCM). The binder may be polyvinylidene fluoride (PVdF). The conductive material may be graphite platelets. A slurry may be prepared by dispersing the cathode active material, the binder and the conductive material in a ratio of 95%, 3% and 2% in N-methyl-2-pyrrolidone (NMP). The slurry may then be coated over an aluminum (Al) foil. The resultant structure may then be subjected to drying and roll pressing and, therefore, a cathode plate may be prepared.

The anode active material may include 70-95% of graphite and 5-30% of Si based on weight ratio. Si included in the anode active material may be at least one of a monolithic Si consisting of pure Si, an Si-carbon composite or an Si-metal composite.

The anode active material including Si may realize a capacity corresponding to several times or more a theoretical capacity (372 mAh/g) of existing graphite-based materials. Therefore, the anode active material may enable preparation of a high-capacity lithium secondary battery.

The assembly process step S200 may be a process of preparing a cell having the form of a battery through processing and assembly of the cathode plate, the anode plate and other materials. The cell may be prepared by assembling the cathode plate and the anode plate under the condition that a separator is interposed between the cathode plate and the anode plate, and then injecting an electrolyte into the resultant assembly. The separator may be a polyethylene (PE) separator and may be coated with a ceramic having a thickness of 10 μm.

In addition, the electrolyte may be prepared by dissolving 1.0M LiPF6 and LiDFOB in a solvent of 20% of ethylene carbonate (EC), 50% of ethylmethyl carbonate (EMC) and 30% of diethyl carbonate (DEC) such that the weight ratio of 1.0M LiPF6 and LiDFOB to the electrolyte is 5%.

The activation process step S300 is a step of charging and discharging the assembled cell, thereby enabling the assembled cell to have electrical characteristics. The prepared cell is then aged and is charged up to a state of charge of 30% (SOC30). Thereafter, the cell is subjected to degassing. Subsequently, a formation process is performed for the cell in a pressurized environment. In the formation process, a formation cycle, in which charge and discharge are carried out a plurality of times, may be performed. In particular, the formation process may be performed in a pressurized environment in which an external pressure is applied to the cell.

When a formation cycle is carried out in the formation process through application of pressure, it may be possible to prepare a lithium secondary battery with a high capacity while suppressing volume swelling of Si. The pressure applied in the formation process may be 0-20 kgf/cm² and may be applied a plurality of times. Referring to experimental examples, which are described below, in an embodiment, a formation cycle in a pressure range of 2-6 kgf/cm² is carried out 1-5 times.

In addition, charge in the formation cycle may be carried out at 0.5C up to 4.2 V under a constant current/constant voltage condition, and discharge in the formation cycle may be carried out at 0.5C up to 2.5 V under a constant current condition.

Hereinafter, examples of the present disclosure and comparative examples are described. Although the examples of the present disclosure and the comparative examples are described in more detail below through experimental examples in order to concretely describe the present disclosure, the present disclosure is not limited thereto. Examples according to the present disclosure may be modified into various forms. The scope of the present disclosure is not to be construed as being limited to the following examples.

### Example 1: Preparation of Lithium Secondary Battery

1-1: Electrode Plate Process Step (S100)

A slurry was prepared by dispersing nickel-cobalt-manganese (NCM) as a cathode active material, polyvinylidene fluoride (PVdF) as a binder and graphite platelets as a conductive material in a ratio of 95:3:2 in a solvent of N-methyl-2-pyrrolidone (NMP). The slurry was then coated over an Al foil. The resultant structure was subsequently subjected to drying and roll pressing. Therefore, a cathode plate was prepared.

An anode plate was prepared using an anode active material consisting of 80% of natural graphite and 20% of Si based on weight ratio.

1-2: Assembly Process Step (S200)

An electrolyte was prepared by dissolving 1.0M lithium hexafluorophosphate (LiPF6) and lithium difluoro(oxalato)borate (LiDFOB) in a solvent of 20% of ethylene carbonate (EC), 50% of ethylmethyl carbonate (EMC) and 30% of diethyl carbonate (DEC) such that the weight ratio of 1.0M LiPF6 and LiDFOB to the electrolyte is 5%.

Thereafter, a cell was prepared by interposing a polyethylene (PE) separator coated with a ceramic having a thickness of 10 μm between the cathode plate and the anode plate prepared in the electrode plate process step S100, winding the resultant assembly, and then injecting an electrolyte into the resultant assembly.

1-3: Activation Process Step (S300)

Thereafter, the assembled cell was aged, and was then charged up to SOC30. Subsequently, the cell was subjected to degassing. Thereafter, a formation process was performed for the cell in a pressurized environment in which a pressure of 2 kgf/cm² is applied. In the formation process, a formation cycle including charge and discharge was performed one time.

Charge in the formation cycle was carried out at 0.5C up to 4.2 V under a constant current-constant voltage condition. Discharge in the formation cycle was carried out at 0.5C up to 2.5 V under a constant current condition.

### Example 2: Preparation of Lithium Secondary Battery

A lithium secondary battery was prepared by performing the same process steps as those of Example 1, except that the formation cycle in the activation process step S300 of Example 1 was carried out 3 times in a pressurized environment in which a pressure of 2 kgf/cm² is applied.

### Example 3: Preparation of Lithium Secondary Battery

A lithium secondary battery was prepared by performing the same process steps as those of Example 1, except that the formation cycle in the activation process step S300 of Example 1 was carried out one time in a pressurized environment in which a pressure of 6 kgf/cm² is applied.

### Example 4: Preparation of Lithium Secondary Battery

A lithium secondary battery was prepared by performing the same process steps as those of Example 1, except that the formation cycle in the activation process step S300 of Example 1 was carried out 3 times in a pressurized environment in which a pressure of 6 kgf/cm² is applied.

### Example 5: Preparation of Lithium Secondary Battery

A lithium secondary battery was prepared by performing the same process steps as those of Example 1, except that the formation cycle in the activation process step S300 of Example 1 was carried out 5 times in a pressurized environment in which a pressure of 6 kgf/cm² is applied.

### Comparative Example 1: Preparation of Lithium Secondary Battery

A lithium secondary battery was prepared by performing the same process steps as those of Example 1, except that the formation cycle in the activation process step S300 of Example 1 was carried out one time in an environment in which no pressure is applied.

### Comparative Example 2: Preparation of Lithium Secondary Battery

A lithium secondary battery was prepared by performing the same process steps as those of Example 1, except that the formation cycle in the activation process step S300 of Example 1 was carried out 3 times in an environment in which no pressure is applied.

### Comparative Example 3: Preparation of Lithium Secondary Battery

A lithium secondary battery was prepared by performing the same process steps as those of Example 1, except that the formation cycle in the activation process step S300 of Example 1 was carried out 10 times in a pressurized environment in which a pressure of 6 kgf/cm² is applied.

### Comparative Example 4: Preparation of Lithium Secondary Battery

A lithium secondary battery was prepared by performing the same process steps as those of Example 1, except that the formation cycle in the activation process step S300 of Example 1 was carried out one time in a pressurized environment in which a pressure of 10 kgf/cm² is applied.

### Comparative Example 5: Preparation of Lithium Secondary Battery

A lithium secondary battery was prepared by performing the same process steps as those of Example 1, except that the formation cycle in the activation process step S300 of Example 1 was carried out 3 times in a pressurized environment in which a pressure of 10 kgf/cm² is applied.

### Experimental Example 1: Measurement of Volume Energy Variation

Volume energy variation was measured for lithium secondary batteries prepared in Examples 3 and 4, and Comparative Examples 1 and 2. For the lithium secondary batteries, volume energy of each lithium secondary battery was measured after execution of the formation process, and was measured after a charge and discharge cycle including full charge and full discharge was carried out 3 times. Resultant measured values of the lithium secondary batteries were compared. The volume energy of a battery is electric power per volume. The unit of volume energy used in the present specification is watt hour (Wh) per liter (L), that is, Wh/L. In addition, calculation of volume energy in each lithium secondary battery was carried out under the condition that the volume energy exhibited after execution of the formation process of Comparative Example 1 in which the formation cycle was carried out one time without pressure application is defined to be 100%. Results are described in Table 1.

TABLE 1

| | Volume Energy Variation (%) | | | |
|---|---|---|---|---|
| | Formation | Number of | After | After |
| | Pressure | Formation | Formation | Charge/Discharge |
| | (kgf/cm²) | Cycles (Times) | Process | Cycle of 3 Times |
| Comp. Ex. 1 | 0 | 1 | 100 | 94.3 |
| Comp. Ex. 2 | 0 | 3 | 94.1 | 93.4 |
| Example 3 | 6 | 1 | 104.2 | 98.2 |
| Example 4 | 6 | 3 | 103.0 | 102.7 |

After comparison of volume energy measured after execution of the charge and discharge cycle of 3 times with volume energy measured after the formation process, it can be seen that volume energy is reduced when the charge and discharge cycle is carried out. The reduction in battery volume energy may be interpreted to be caused by volume swelling according to inclusion of Si in the anode active material. Accordingly, results of volume swelling may be found through comparison of volume energy variations.

After comparison of Examples 3 and 4 with Comparative Examples 1 and 2 in Table 1, it can be seen that volume energy increases in a pressurized environment. It can also be seen that volume energy in the case in which the formation cycle is carried out 3 times is reduced, as compared to the case in which the formation cycle is carried out one time.

In more detail, when volume energy exhibited after execution of the formation process in Comparative Example 1 is compared with volume energy exhibited after execution of each formation process in Comparative Example 2, Example 3 and Example 4, it can be seen that volume is relatively swelled in Comparative Example 2, whereas volume is relatively shrunken in Examples 3 and 4. Accordingly, it may be inferred that a reduction in battery volume occurs after execution of a formation process when the formation process is carried out in a pressurized environment.

In addition, after volume energy comparison of the cases in which the charge and discharge cycle is carried out 3 times, it can be seen that volume energy is reduced when the formation process is carried out in a pressurized environment.

In particular, after comparison of Examples 3 and 4, the difference between the case in which the formation cycle is carried out one time and the case in which the formation cycle is carried out three times can be seen. The volume energy after execution of the formation process in Example 3 is exhibited to be 104.2%, greater than 103.0% exhibited in Example 4. However, the volume energy exhibited after execution of the charge and discharge cycle of 3 times in Example 4 is 102.7%, greater than 98.2% in Example 3. Thus, it can be seen that the volume swelling in the case in which the formation cycle is carried out 3 times is reduced, as compared to the case in which the formation cycle is carried out one time.

Consequently, it can be seen through Experimental Example 1 that, when the formation cycle is carried out in the pressurized environment, the volume swelling problem caused by Si can be solved.

### Experimental Example 2: Durability Improvement

The lithium secondary batteries prepared in Examples 1-5 and Comparative Examples 1-5 were tested for durability variation. For each lithium secondary battery, the thickness and discharge capacity of the cell were measured in a fully charged state after execution of the formation process. After the charge and discharge cycle was executed 120 times at high speed, the thickness, discharge capacity and resistance of the cell were measured. Results are described in Table 2. Values of the results are described as ratios to initial values thereof, respectively. Each discharge capacity is described as capacity retention.

TABLE 2

| | | Number of | Cell | | |
|---|---|---|---|---|---|
| | Formation | Formation | Thickness | Capacity | Resistance |
| | Pressure | Cycles | Variation | Retention | Increase |
| | (kgf/cm²) | (Times) | (%) | (%) | (%) |
| Comp. Ex. 1 | 0 | 1 | 120 | 75 | 180 |
| Comp. Ex. 2 | 0 | 3 | 120 | 74 | 183 |
| Example 1 | 2 | 1 | 119 | 77 | 178 |
| Example 2 | 2 | 3 | 118 | 79 | 176 |
| Example 3 | 6 | 1 | 115 | 80 | 161 |
| Example 4 | 6 | 3 | 110 | 85 | 154 |
| Example 5 | 6 | 5 | 110 | 86 | 152 |
| Comp. Ex. 3 | 6 | 10 | 108 | 85 | 153 |
| Comp. Ex. 4 | 10 | 1 | 107 | 74 | 166 |
| Comp. Ex. 5 | 10 | 3 | 107 | 73 | 169 |

After referring to Table 2 in association with cell thickness variation exhibited after execution of the charge and discharge cycle, it can be seen that Comparative Examples 1 and 2, in which the formation process was carried out in an environment in which no pressure is applied, exhibit a greatest value of 120%. On the other hand, it can be seen that Examples 1-5 and Comparative Examples 3-5, in which the formation process was carried out in a pressurized environment, exhibit a reduction in cell thickness variation. This may be interpreted as being caused by suppression of volume swelling according to Si.

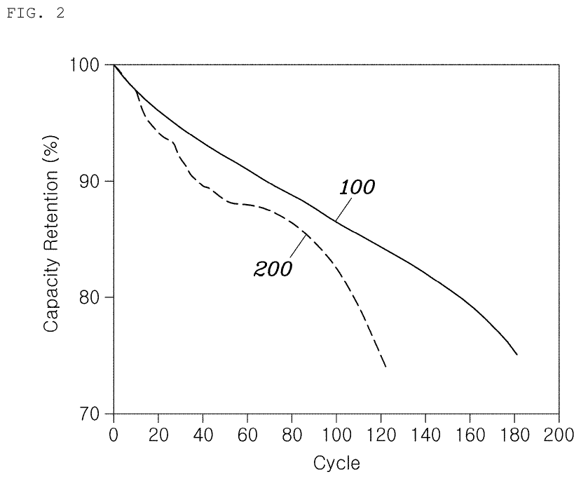

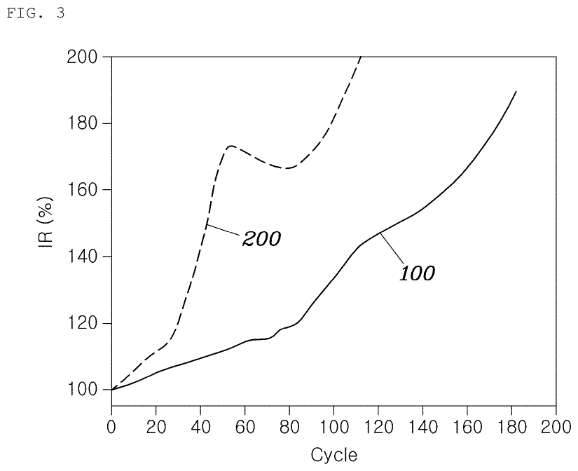

FIG. 2 is a graph depicting discharge capacity retention variation according to execution of the charge and discharge cycle in a lithium secondary battery 100 of Example 4 and a lithium second battery 200 of Comparative Example 1. FIG. 3 is a graph depicting resistance increase (IR) variation according to execution of the charge and discharge cycle in the lithium secondary battery 100 of Example 4 and the lithium second battery 200 of Comparative Example 1.

Referring to Table 2 and FIG. 2 in association with discharge capacity retention, it can be seen that high discharge capacity retention is exhibited when the formation process is carried out in a pressurized environment. Of course, it can also be seen that the discharge capacity retention in Comparative Examples 4 and 5 is rather reduced, as compared to those of Comparative Examples 1 and 2. This may be inferred as being due to performance degradation resulting from cell deformation caused by an excessive pressure and, as such, electrolyte leakage. Thus, it can be seen that, when the formation process is carried out in a pressurized environment of 6 kgf/cm², performance degradation rather occurs.

Referring to FIG. 2, it can be seen that the lithium secondary battery 100 of Example 4 in which the formation process is carried out in a pressurized environment exhibits lower capacity reduction than the lithium secondary battery 200 of Comparative Example 1 in accordance with an increase in the number of charge and discharge cycles. Thus, it can be seen that lithium secondary batteries prepared through execution of the formation process in a pressurized environment exhibit superior capacity retention performance.

Referring to Table 2 and FIG. 3 in association with resistance increase (IR), it can be seen that Comparative Examples 1 and 2 exhibit a resistance increase of 180% and 183%, respectively. The remaining cases in which the formation process is carried out in a pressurized environment exhibit lower resistance increase than the former cases. In particular, it can be seen that lowest resistance increase is exhibited when the formation process is carried out in a pressurized environment of 6 kgf/cm². Thus, it can be seen that, when the formation process is carried out in a pressurized environment, battery performance is enhanced in accordance with lowered resistance increase.

Referring to FIG. 3, it can be seen that the lithium secondary battery 100 of Example 4 in which the formation process is carried out in a pressurized environment exhibits lower resistance increase than the lithium secondary battery 200 of Comparative Example 1 in accordance with an increase in the number of charge and discharge cycles. Thus, it can be seen that lithium secondary batteries prepared through execution of the formation process in a pressurized environment exhibit superior battery performance in accordance with lowered resistance increase.

Consequently, Examples 1-5 exhibit excellent cell thickness variation, capacity retention and resistance increase. It can be seen that, in the embodiment of Example 5, when the formation cycle is carried out 5 times at a pressure of 6 kgf/cm², excellent effects are obtained.

It can be seen that, as the formation cycle is carried out an increased number of times, charge uniformity is enhanced and, therefore, performance is enhanced. However, results obtained in Comparative Example 3 in which the formation cycle is carried out 10 times at a pressure of 6 kgf/cm² do not exhibit significant differences from those of Example 5 in which the formation cycle is carried out 5 times at the same pressure. Thus, it can be seen that, even when the formation cycle is carried out 5 times or more, there is no significant performance enhancement effect according to repeated execution of the formation cycle. Accordingly, execution of the formation cycle of 5 times or less may be estimated to be efficient in terms of economy.

### Experimental Example 3: SEM Photograph

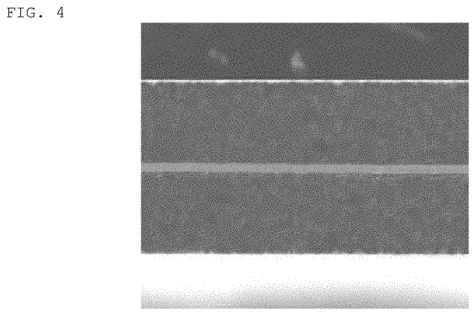

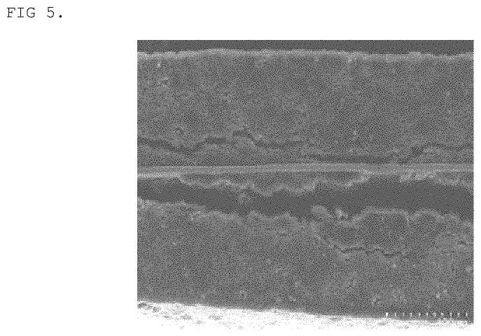

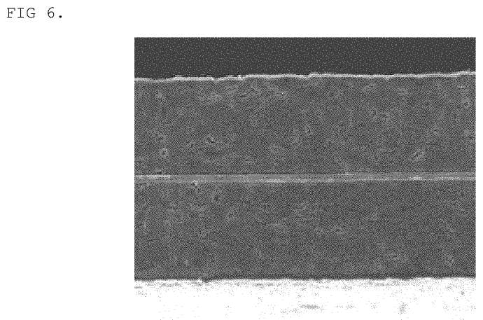

FIG. 4 is a scanning electron microscope (SEM) photograph of the cell assembled in the assembly process step S200. SEM photographs of lithium secondary batteries prepared in Comparative Example 1 and Example 4 after execution of Experimental Example 2 were identified. Results thereof are shown in FIGS. 5 and 6.

Referring to FIG. 4, it can be seen that an anode has been stably formed with a coating layer just after execution of the assembly process step S200. However, as shown in FIG. 5, it can be seen that, when the charge and discharge cycle is carried out, cracks may be formed at Si particles due to volume swelling of Si. Therefore, Si particles may be refined, thereby causing damage to the anode. For this reason, when a conventional formation process is carried out under the condition that Si is included in an anode active material, there may be a problem in that the function of the resultant lithium secondary battery may be degraded.

Referring to FIG. 5, it can be seen that, in the case in which the formation process is carried out in a pressurized environment, durability of the anode is retained even if a charge and a discharge cycle is carried out. Accordingly, referring to FIGS. 4-6, it can be seen that, in the lithium secondary battery prepared by the preparation method according to the embodiment of the present disclosure, a desired grain structure thereof is reliably retained even after execution of the charge and discharge cycle.

Referring to Experimental Examples 1-3, it can be seen that lithium secondary batteries prepared by lithium secondary battery preparation methods according to Embodiments 1-5 of the present disclosure have superior electrical characteristics and durability while solving a volume swelling problem in accordance with inclusion of Si in an anode plate.

As is apparent from the above description, in accordance with the lithium secondary battery preparation method of the present disclosure, a formation process is carried out through pressure application in a procedure of preparing a lithium secondary battery including an Si-based anode. Therefore, it may be possible to prepare a lithium secondary battery with a high capacity while solving a volume swelling problem. Accordingly, a lithium secondary battery having a high capacity and a high output power may be prepared. In this regard, the lithium secondary battery preparation method of the present disclosure may be usefully used in preparation of lithium secondary batteries.

In addition, the lithium secondary battery preparation method of the present disclosure may use simple processes and, as such, may be easily commercially available and easily implemented.

Although various embodiments of the present disclosure have been disclosed for illustrative purposes, those of ordinary skill in the art should appreciate that various modifications, additions and substitutions are possible, without departing from the scope and spirit of the disclosure as disclosed in the accompanying claims.

What is claimed is:

1. A method for preparing a lithium secondary battery including Silicon (Si) in an anode, the method comprising:
an electrode plate process step of preparing a cathode plate using a cathode active material, a conductive material and a binder, and of preparing an anode plate using an anode active material including Si, a conductive material, and a binder;
an assembly process step of assembling the cathode plate and the anode plate in a state in which a separator is interposed between the cathode plate and the anode plate, and of injecting an electrolyte into the resultant assembly, thereby preparing a cell; and
an activation process step of aging and degassing the prepared cell and of performing a formation process for the cell in a pressurized environment, thereby suppressing volume swelling of the cell.

2. The method according to claim 1, wherein, in the electrode plate process step, the anode active material comprises 70-95% of graphite and 5-30% of Si based on weight ratio.

3. The method according to claim 2, wherein Si comprises at least one of a monolithic Si, an Si-carbon composite or an Si-metal composite.

4. The method according to claim 1, wherein the pressurized environment of the formation process in the activation process step is an environment having a pressure of 2-6 kgf/cm².

5. The method according to claim 4, wherein the formation process in the activation process step comprises execution of a formation cycle, in which a charge and a discharge of the cell are carried out a plurality of times, in a pressurized environment.

6. The method according to claim 5, wherein the formation cycle is executed 1-5 times.

7. The method according to claim 5, wherein charge in the formation cycle is carried out at 0.5C up to 4.2 V under a constant current-constant voltage condition.

8. The method according to claim 5, wherein discharge in the formation cycle is carried out at 0.5C up to 2.5 V under a constant current condition.

9. The method according to claim 1, wherein, in the electrode plate process step, the cathode active material is nickel-cobalt-manganese (NCM), the binder is polyvinylidene fluoride (PVdF), and the conductive material is graphite platelets.

10. The method according to claim 9, wherein the electrode plate process step comprises preparing a slurry by dispersing the cathode active material, the binder and the conductive material in a ratio of 95%, 3% and 2% in N-methyl-2-pyrrolidone (NMP), coating the prepared slurry over an aluminum (Al) foil, and then subjecting the resultant structure to drying and roll pressing, thereby preparing a cathode plate.

11. The method according to claim 1, wherein the separator in the assembly process step is a polyethylene (PE) separator coated with a ceramic having a thickness of 10 μm.

12. The method according to claim 1, wherein the electrolyte in the assembly process step is prepared by dissolving 1.0M lithium hexafluorophosphate (LiPF6) and lithium difluoro(oxalato)borate (LiDFOB) in a solvent of 20% of ethylene carbonate (EC), 50% of ethylmethyl carbonate (EMC) and 30% of diethyl carbonate (DEC) such that the weight ratio of 1.0M LiPF6 and LiDFOB to the electrolyte is 5%.

13. A lithium secondary battery prepared by the method of claim 1.
